(19) United States
(12) Patent Application Publication
(10) Pub. No.: US 2003/0110882 A1
(43) Pub. Date: Jun. 19, 2003

(54) Vehicle steering wheel

(75) Inventor: John-Oliver Derrick, Hettstadt (DE)

Correspondence Address: TAROLLI, SUNDHEIM, COVELL, TUMMINO & SZABO LLP, 1111 LEADER BUILDING, 526 SUPERIOR AVENUE, CLEVEVLAND, OH, 44114-1400, US

(73) Assignee: TRW Automotive Safety Systems GmbH & Co. KG

(21) Appl. No.: 10/316,724

(22) Filed: Dec. 11, 2002

(30) Foreign Application Priority Data
Dec. 13, 2001 (DE) 101 61 348.2

(51) Int. Cl. B62D 1/04

(52) U.S. Cl. 74/552

(57) ABSTRACT

A vehicle steering wheel has a skeleton that is made by using a metal foam, preferably on the basis of aluminum, magnesium and their alloys. The density of the metal foam lies between 0.3 and 1.0 g/cm³. The modulus of elasticity of the skeleton lies in the range from 2 to 14 GPa.

### TECHNICAL FIELD

The present invention relates to a vehicle steering wheel comprising a steering wheel skeleton.

### BACKGROUND OF THE INVENTION

For steering wheel skeletons, a general requirement exists for low weight and high mechanical load-bearing capacity. Normally, steering wheel skeletons are made of steel or sheet metal. Moreover, production by means of magnesium pressure diecasting or aluminum pressure diecasting has been described. A combination of these mentioned materials can also be used. Thus, for example, steering wheel skeletons are known that are made of zinc-coated sheet metal parts and that have a cast-on hub made of a magnesium alloy. Furthermore, steering wheel skeletons are known in which the steering wheel rim and the steering wheel spokes are made of round bar steel or flat steel and a hub is made of pressure-die-cast aluminum into which the steering wheel spokes are embedded by casting.

A drawback of the known steering wheel skeleton is that the requirement made on these components, namely, high strength coupled with low weight, cannot be optimally met. For example, through the use of steel as the material, high mechanical strength of the skeleton and especially of the steering wheel rim can be ensured. However, the skeletons made in this manner are too heavy and no longer meet the requirements of the automotive industry. The use of magnesium and aluminum as the material for the above-mentioned components results in a lower weight, but some of the parts made of these materials likewise do not meet the higher strength requirements in case of a car accident.

New developments have shown that metal foams on the basis of aluminum or magnesium are likewise suitable as lightweight materials. A powder-metallurgic method of producing an aluminum foam is described, for example, in DE 40 18 360 C1. However, this patent specification merely contains the suggestion to use metal foams for manufacturing crash zones and side parts of vehicles. Further methods of producing metal foams and shaped bodies formed therefrom are disclosed in DE 199 07 855 C1 and DE 197 17 894 A1.

### BRIEF SUMMARY OF THE INVENTION

The invention provides a steering wheel comprising a steering wheel skeleton that meets the increased requirements of the automotive industry for such components in terms of low weight and, at the same time, high mechanical strength. According to the invention, a vehicle steering wheel comprising a steering wheel skeleton is provided for this purpose, the steering wheel skeleton being at least partially made by using a metal foam.

Especially preferably, the steering wheel skeleton has a steering wheel rim made by using the metal foam.

The metal foam is preferably a light metal foam, and especially preferably a metal foam on the basis of aluminum, magnesium or their alloys, such as, for example, AlCu4, AlSil2, AlSi7, AlMg4 or AlMg1SiCu. These alloys have particularly good mechanical strength properties.

As the metal foam, a closed-cell foam is advantageously used which has a higher strength than an open-cell foam. The metal foam can be a so-called “syntactic” foam that consists of ceramic hollow beads introduced into a metal matrix. The ceramic hollow beads preferably consist of aluminum oxide, mullite or titanium oxide, and they have a diameter of 1 mm to 5 mm with wall thicknesses between 50 μm and 250 μm. The bulk density of the hollow beads lies in the range from 0.2 to 0.9 grams per cm³. The use of syntactic metal foams makes it possible to selectively set product parameters over a large range.

The syntactic metal foams are produced by the infiltration casting process in which the metal melt is pressed under pressure into an infiltration capsule filled with the ceramic hollow beads. Another possibility is to line an outer skin structure or shell that is filled with the hollow beads and that can be configured here in the shape of the steering wheel skeleton or of the steering wheel rim.

Moreover, the metal foams that can be used according to the invention for the production of the steering wheel skeleton can be made by means of a powder-metallurgical process of the type known, for example, from DE 40 18 360 C1. In this process, metal powders such as, for instance, aluminum, magnesium or their alloys are mixed with a foaming agent powder such as, for example, titanium hydride (TiH₂). Then the powder mixture is compacted by means of a known compacting process such as extruding, uniaxial or isostatic hot press molding or coextrusion. This process step yields a semifinished product which, if desired, can be further processed by means of conventional shaping techniques. According to the invention, a lamination with sheet metal can also be carried out here. The subsequent heating of the semifinished product to a temperature above the solid temperature of the metal powder in question gives rise to a highly porous, closed-cell metal foam that can already have the shape of the final steering wheel skeleton or steering wheel rim.

The metal foams that can be used according to the invention preferably have a density between 0.3 and 1.0 g/cm³. Especially advantageous for use as a steering wheel skeleton are metal foams with a modulus of elasticity between 2.0 and 14 GPa.

Especially preferably, the metal foams are introduced into a metal frame or metal shell made of steel or aluminum sheet metal. In this manner, the shaping and processing are facilitated since the heating and expansion of the compacted metal powder to form the metal foam can be carried out in the metal shell without the use of special molding tools and, at the same time, the metallurgical bond between the metal shell and the metal foam increases the stability of the skeleton construction.

Thus, the subject matter of the invention is also the use of metal foams for the production of steering wheel skeletons.

The steering wheels according to the invention exhibit a high mechanical strength with low weight and, especially in case of a car accident, account for a high energy absorption.

The invention will be described below with reference to the production of a steering wheel skeleton with a steering wheel rim made of metal foam. Fundamentally, however, other parts of the steering wheel skeleton such as the spokes and the hub can also be made by using the metal foam.

### DETAILED DESCRIPTION OF THE PREFERRED EMBODIMENT

According to a particularly preferred embodiment, the steering wheel skeleton consisting essentially of the steering wheel hub, steering wheel spokes and steering wheel rim is made of metal foam in one piece.

In order to increase the mechanical strength, the metal foam can be laminated with a steel or aluminum sheet metal. The metal foam is preferably an aluminum foam. However, it is also possible to use metal foams on the basis of aluminum alloys as well as magnesium or magnesium alloys.

The properties of the metal foam can be adjusted over a wide range by means of a suitable selection of the density and pore size. Preferably, the pore size lies between 1 mm and 5 mm, and the density between 0.3 and 1.0 g/cm³. For use as a steering wheel skeleton, a modulus of elasticity between 2.0 and 14 GPa is advantageous.

In order to produce the steering wheel skeleton, first of all, aluminum powder and titanium hydride powder as the foaming agent are mixed together and compacted, for example, by means of extrusion. The amount of foaming agent is preferably less than 1% by weight of the mixture. The compacted mixture is introduced into a hollow mold for the finished steering wheel skeleton. In this hollow mold, the powder mixture is expanded by heating, thus resulting in a highly porous, closed-cell structure with a continuous outer skin.

In an advantageous manner, a steel or aluminum sheet metal may already be inserted in the hollow mold. In this case, over the course of the heating, a metallurgical bond is formed between the metal foam and the sheet metal frame. The metal foam can be wrapped up in the sheet metal frame or surround the latter, in this way strengthening the metal foam. As an alternative, a semifinished product that is laminated with steel or aluminum sheet metal can be produced from the compacted powder mixture by means of shaping processes, which semifinished product already has the shape of the finished steering wheel skeleton or steering wheel rim. The powder mixture can then be expanded to form the metal foam by means of controlled heating of the semifinished product in an oven. The introduction into a separate mold is no longer necessary in this case.

The amount of foaming agent powder as well as the heating temperature and time can be varied to select the density and the porosity of the metal foam. Advantageous densities are those in the range from 0.3 to 1 g/cm³, corresponding to a porosity of up to about 90% at a mean pore diameter ranging from 1 mm to 5 mm.

The steering wheel skeleton made in this manner has a lower weight and greater strength in comparison to conventional steering wheel skeletons.

1. A vehicle steering wheel comprising a steering wheel skeleton, the improvement consisting in that said steering wheel skeleton is at least partially made by using a metal foam.

2. The vehicle steering wheel according to claim 1, wherein said metal foam is preferably a light metal foam.

3. The vehicle steering wheel according to claim 2, wherein said light metal foam is selected from the group consisting of foams of aluminum, magnesium and their alloys.

4. The vehicle steering wheel according to claim 1, wherein said metal foam is a closed-cell foam.

5. The vehicle steering wheel according to claim 1, wherein said metal foam is a syntactic foam.

6. The vehicle steering wheel according to claim 5, wherein said metal foam can be obtained by placing ceramic hollow beads into a mold and introducing a metal melt into said mold by one of infiltration under pressure and casting.

7. The vehicle steering wheel according to claim 6, wherein said ceramic hollow beads are arranged in a shell made of sheet metal.

8. The vehicle steering wheel according to claim 1, wherein said metal foam can be obtained by mixing a metal powder and a foaming agent powder in order to form a foamable mixture, by compacting said foamable mixture so as to form a semifinished product and by heating said semifinished product so as to form said metal foam.

9. The vehicle steering wheel according to claim 1, wherein said metal foam has a density between 0.3 and 1.0 g/cm³.

10. The vehicle steering wheel according to claim 1, wherein said metal foam has a modulus of elasticity between 2.0 and 14 GPa.

11. The vehicle steering wheel according to claim 1, wherein said metal foam is introduced into a sheet metal shell.

12. The vehicle steering wheel according to claim 11, wherein the material for said metal shell is selected from the group consisting of steel and aluminum sheet metal.

13. The vehicle steering wheel according to claim 1, wherein said steering wheel skeleton has a steering wheel rim made by using said metal foam.

14. A method of producing a vehicle steering wheel comprising a steering wheel skeleton which is at least partially made by using a metal foam, the method comprising the following steps: mixing a metal powder and a foaming agent powder in order to form a foamable mixture, compacting said mixture and heating it under degradation of said foaming agent powder in order to form a metal foam, said metal foam being formed in a mold for said steering wheel skeleton.

15. The method according to claim 14, wherein, as said mold for said steering wheel skeleton, a molding tool is used into which one of a steel and aluminum sheet metal is laid in order to envelop or strengthen said metal foam.

16. The method according to claim 14, wherein, as said mold for said steering wheel skeleton, a shell of one of steel and aluminum sheet metal is used that is applied onto said compacted mixture by means of deforming it.

17. A use of a metal foam in the production of a steering wheel with a steering wheel skeleton that is at least partially made by using a metal foam.
